(19) United States
(12) Patent Application Publication
(10) Pub. No.: US 2023/0249648 A1
(43) Pub. Date: Aug. 10, 2023

(54) INFORMATION PROCESSING APPARATUS, INFORMATION PROCESSING SYSTEM, AND INFORMATION PROCESSING METHOD

(71) Applicant: TOYOTA JIDOSHA KABUSHIKI KAISHA, Toyota-shi (JP)

(72) Inventors: Mitsuhiro MIURA, Nagoya-shi (JP); Kenichi YAMADA, Nisshin-shi (JP); Satoshi KOMAMINE, Nagoya-shi (JP); Fumiyuki KAGARA, Sagamihara-shi (JP); Go TANAKA, Toyota-shi (JP); Hiroyuki NISHIZAWA, Tokyo-to (JP)

(73) Assignee: TOYOTA JIDOSHA KABUSHIKI KAISHA, Toyota-shi (JP)

(21) Appl. No.: 18/165,832

(22) Filed: Feb. 7, 2023

(30) Foreign Application Priority Data
Feb. 7, 2022 (JP) 2022-017493

(51) Int. Cl. B60R 25/24; G07C 5/00; B60R 25/01; B60R 25/10

(52) U.S. Cl. CPC B60R 25/24; G07C 5/008; B60R 25/01; B60R 25/10

(57) ABSTRACT

An information processing apparatus includes a controller. The controller acquires a user condition that is a condition for a user to be a target to whom an object is to be kept secret. The controller determines whether a user matching the user condition is likely to take a target vehicle transporting the object.

### CROSS-REFERENCE TO RELATED APPLICATION

This application claims priority to Japanese Patent Application No. 2022-017493 filed on Feb. 7, 2022, the entire contents of which are incorporated herein by reference.

### TECHNICAL FIELD

The present disclosure relates to an information processing apparatus, an information processing system, and an information processing method.

### BACKGROUND

Technology for freight and passenger consolidation in which passengers and luggage or cargo are transported or operated together is known. For example, Patent Literature (PTL) 1 discloses an information processing apparatus that manages operations of autonomous vehicles with loading space for luggage. A controller of the information processing apparatus described in PTL 1 extracts an autonomous vehicle that has, in its loading space, free space large enough to accommodate a user at the user's desired ride section and ride time, based on free space information on each autonomous vehicle.

### CITATION LIST

### Patent Literature

PTL 1: JP 2020-149576 A

### SUMMARY

In freight and passenger consolidation, for example, an object not to be seen by passengers is sometimes transported. In this case, the confidentiality of the object to be transported must be ensured.

It would be helpful to ensure the confidentiality of an object to be transported.

An information processing apparatus according to an embodiment of the present disclosure includes a controller configured to:

acquire a user condition being a condition for a user to be a target to whom an object is to be kept secret; and

determine whether a user matching the user condition is likely to take a target vehicle transporting the object.

An information processing system according to an embodiment of the present disclosure includes:

the information processing apparatus; and

at least one vehicle including the target vehicle.

An information processing method according to an embodiment of the present disclosure includes:

acquiring a user condition being a condition for a user to be a target to whom an object is to be kept secret; and

determining whether a user matching the user condition is likely to take a target vehicle transporting the object.

According to an embodiment of the present disclosure, it is possible to ensure the confidentiality of the object to be transported.

### BRIEF DESCRIPTION OF THE DRAWINGS

In the accompanying drawings:

FIG. 1 is a diagram illustrating a schematic configuration of an information processing system according to an embodiment of the present disclosure;

FIG. 2 is a block diagram of the information processing system illustrated in FIG. 1; and

FIG. 3 is a flowchart illustrating operations of an information processing apparatus illustrated in FIG. 2.

### DETAILED DESCRIPTION

An embodiment of the present disclosure will be described below, with reference to the drawings.

(Configuration of Information Processing System)

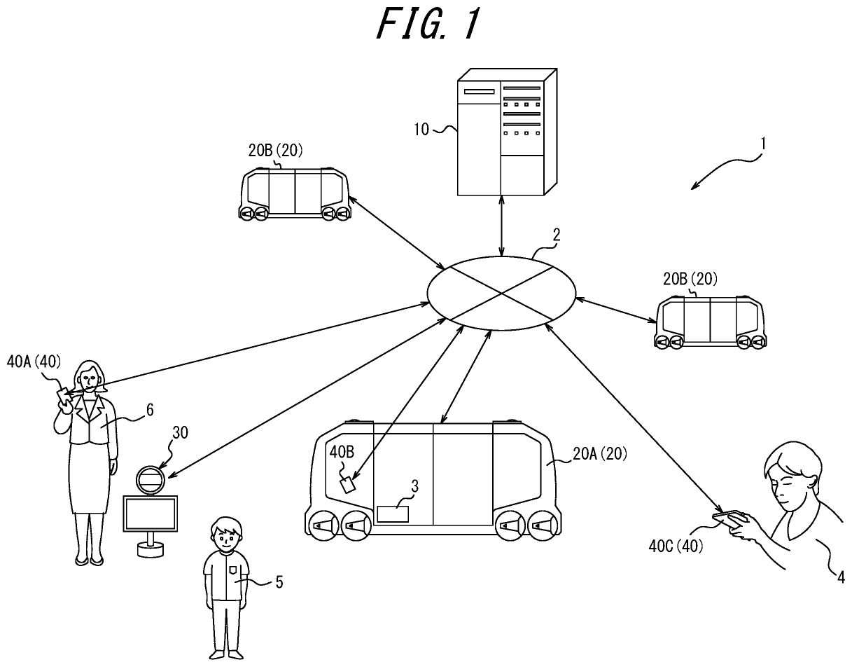

As illustrated in FIG. 1, an information processing system 1 includes at least one information processing apparatus 10, one or more vehicles 20, at least one terminal apparatus 30, a terminal apparatus 40A, a terminal apparatus 40B, and a terminal apparatus 40C. However, the information processing system 1 does not necessarily include the terminal apparatus 30, the terminal apparatus 40A, the terminal apparatus 40B, and/or the terminal apparatus 40C. The information processing system 1 may not include the multiple vehicles 20. The information processing system 1 should include at least one vehicle 20.

In the following, the terminal apparatus 40A, the terminal apparatus 40B, and the terminal apparatus 40C are also collectively referred to as “terminal apparatuses 40” unless particularly distinguished.

The information processing apparatus 10, the vehicles 20, the terminal apparatus 30, and the terminal apparatuses 40 are communicable via a network 2. The network 2 may be any network including a mobile communication network, the Internet, and the like.

The information processing apparatus 10 manages operations of the vehicles 20. The information processing apparatus 10 is, for example, a dedicated computer configured to function as a server, a general purpose personal computer, a cloud computing system, or the like.

In the present embodiment, the vehicles 20 circulate within a predetermined facility. However, the vehicles 20 may travel anywhere other than within the facility. The facility in which the vehicles 20 circulate is, for example, a facility such as a factory or a corporate plant. In the present embodiment, the vehicles 20 circulate a predetermined route within the facility. At least one stop, for example, is set up on the route that the vehicles 20 circulate. Users get on the vehicles 20 at the stop, for example. Any user can take the vehicles 20.

The vehicles 20 are capable of transporting the users and an object 3 at the same time. The object 3 may be any object. The object 3 is, for example, a part or the like used in a plant of the facility. The object 3 may be an unpublished part or a general purpose part. The object 3 is managed by a manager 4. The manager 4 manages transportation of the object 3 by any of the vehicles 20 to a predetermined destination in the facility. The manager 4 loads the object 3 into the vehicle 20. The manager 4 may get on the vehicle 20 and travel with the object 3 to the destination. The manager 4 does not necessarily have to take the vehicle 20. That is, only the object 3 may be transported by the vehicle 20 to the destination.

Each of the vehicles 20 may be any type of automobile. Each of the vehicles 20 is, for example, a gasoline automobile, a battery electric vehicle (BEV), a hybrid electric vehicle (HEV), a plug-in hybrid electric vehicle (PHEV), a fuel cell electric vehicle (FCEV), or the like. The vehicles 20 may be driven by drivers. The driving of each of the vehicles 20 may be partly automated at any level. The level of automation is, for example, one of level 1 to level 5 according to the classification of the Society of Automotive Engineers (SAE). The vehicles 20 may be dedicated Mobility as a Service (MaaS) vehicles.

Hereafter, the vehicle 20 that is transporting the object 3 is also referred to as “target vehicle 20A”. The vehicles 20 that are transporting no object 3 are also each referred to as “vehicle 20B”.

The terminal apparatus 30 is located at a stop on the route that the vehicles 20 circulate. The terminal apparatus 30 is, for example, a digital signage, an output apparatus that outputs sound, or the like.

At the stop where the terminal apparatus 30 is located, a visitor 5 and an escort 6 are waiting. The visitor 5 tours the facility. The escort 6 leads the visitor 5. The escort 6 is, for example, an employee of the facility. In the present embodiment, the employee of the facility includes an employee who works for a corporation that operates or manages the facility, or the like. The visitor 5 and the escort 6 are waiting at the stop to take any of the vehicles 20.

The terminal apparatus 40A is used by the escort 6. The terminal apparatus 40B is used by the manager 4. The terminal apparatus 40C is used by a driver of the target vehicle 20A.

Each of the terminal apparatuses 40 may be any apparatus, which can be connected to the network 2. Each of the terminal apparatuses 40 is, for example, a mobile phone, a smartphone, a tablet, a personal computer (PC), or the like. However, the terminal apparatus 40B of the driver may be an in-vehicle device such as a car navigation apparatus installed in the vehicle 20.

<Configuration of Information Processing Apparatus>

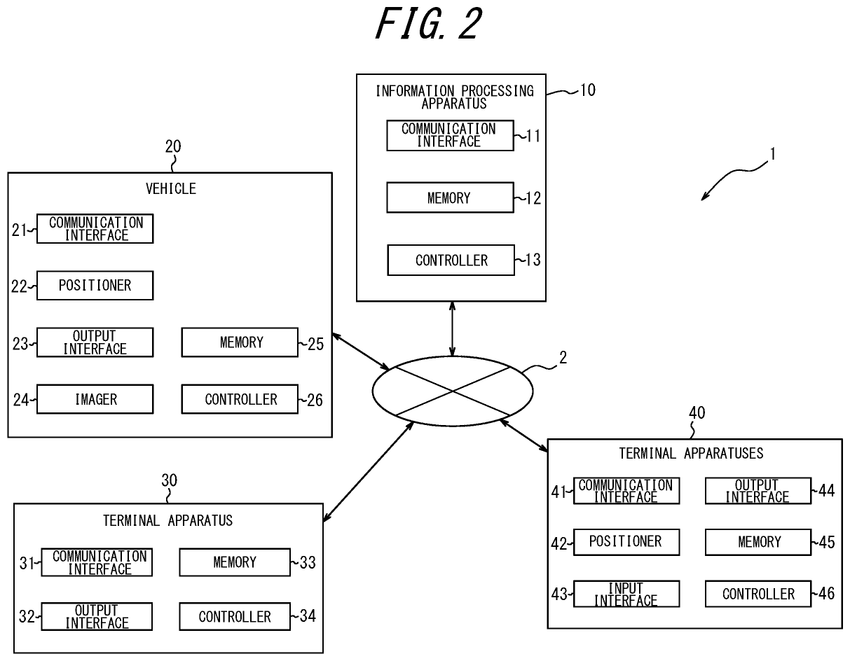

As illustrated in FIG. 2, the information processing apparatus 10 includes a communication interface 11, a memory 12, and a controller 13.

The communication interface 11 is configured to include at least one communication module for connection to the network 2. For example, the communication module is a communication module compliant with a standard such as a wired Local Area Network (LAN) or a wireless LAN. However, the communication module is not limited to this. The communication module may be compliant with any communication standard. The communication interface 11 is connectable to the network 2 via a wired LAN or a wireless LAN using the communication module.

The memory 12 is configured to include at least one semiconductor memory, at least one magnetic memory, at least one optical memory, or a combination of at least two of these. The semiconductor memory is, for example, random access memory (RAM), read only memory (ROM), or the like. The RAM is, for example, static random access memory (SRAM), dynamic random access memory (DRAM), or the like. The ROM is, for example, electrically erasable programmable read only memory (EEPROM) or the like. The memory 12 may function as a main memory, an auxiliary memory, or a cache memory. The memory 12 stores data to be used in operations of the information processing apparatus 10 and data obtained by the operations of the information processing apparatus 10.

The controller 13 is configured to include at least one processor, at least one dedicated circuit, or a combination thereof. The processor is, for example, a general purpose processor such as a central processing unit (CPU) or a graphics processing unit (GPU), or a dedicated processor that is dedicated to specific processing. The dedicated circuit is, for example, a field-programmable gate array (FPGA), an application specific integrated circuit (ASIC), or the like. The controller 13 executes processes related to the operations of the information processing apparatus 10 while controlling the components of the information processing apparatus 10.

The functions of the information processing apparatus 10 is implemented by executing a processing program according to the present embodiment by a processor corresponding to the controller 13. That is, the functions of the information processing apparatus 10 may be implemented by software. The processing program enables a computer to function as the information processing apparatus 10 by causing the computer to execute the operations of the information processing apparatus 10. That is, the computer functions as the information processing apparatus 10, by executing the operations of the information processing apparatus 10 in accordance with the processing program.

Some or all of the functions of the information processing apparatus 10 may be realized by a dedicated circuit corresponding to the controller 13. That is, some or all of the functions of the information processing apparatus 10 may be realized by hardware.

The controller 13 can control the communication interface 11 to receive positional information on the vehicles 20 from the vehicles 20 via the network 2. The controller 13 may control the memory 12 to store the received positional information on the vehicles 20 in association with times at which the positional information on the vehicles 20 has been received. The controller 13 can control the communication interface 11 to receive positional information on the terminal apparatuses 40 from the terminal apparatuses 40 via the network 2. The controller 13 may control the memory 12 to store the received positional information on the terminal apparatuses 40 in association with times at which the positional information on the terminal apparatuses 40 has been received.

<Configuration of Vehicle>

As illustrated in FIG. 2, each vehicle 20 includes a communication interface 21, a positioner 22, an output interface 23, an imager 24, a memory 25, and a controller 26.

The communication interface 21 is configured to include at least one communication module for connection to the network 2. The communication module is, for example, a communication module compliant with a mobile communication standard such as Long Term Evolution (LTE), 4th Generation (4G), or 5th Generation (5G). However, the communication module is not limited to this. The communication module may be compliant with any communication standard.

The communication interface 21 may be configured to further include a communication module compliant with contactless communication standards. The contactless communication standards include, for example, the Near Field Communication (NFC) standards or the like.

The positioner 22 is capable of acquiring positional information on the vehicle 20. The positioner 22 is configured to include at least one receiving module compliant with a satellite positioning system. The receiving module is, for example, a receiving module corresponding to the Global Positioning System (GPS). However, the receiving module is not limited to this. The receiving module may be a receiving module corresponding to any appropriate satellite positioning system.

The output interface 23 is capable of outputting data. The output interface 23 is configured to include at least one interface for output that is capable of outputting data. The interface for output is, for example, a display, a speaker, or the like. The display is, for example, a liquid crystal display (LCD), an organic electro-luminescent (EL) display, or the like. However, the interface for output is not limited to this.

The imager 24 is configured to include at least one camera capable of imaging a subject. The imager 24 is disposed at a position so as to image users in the vicinity of an entrance/exit of the vehicle 20 as subjects.

The memory 25 is configured to include at least one semiconductor memory, at least one magnetic memory, at least one optical memory, or a combination of at least two of these. The semiconductor memory is, for example, RAM, ROM, or the like. The RAM is, for example, SRAM, DRAM, or the like. The ROM is, for example, EEPROM or the like. The memory 25 may function as, for example, a main memory, an auxiliary memory, or a cache memory. The memory 25 stores data to be used for operations of the vehicle 20 and data obtained by the operations of the vehicle 20.

The controller 26 is configured to include at least one processor, at least one dedicated circuit, or a combination thereof. The processor is, for example, a general purpose processor such as a CPU or a GPU, or a dedicated processor that is dedicated to a specific process. The dedicated circuit is, for example, an FPGA, an ASIC, or the like. The controller 26 executes processes related to the operations of the vehicle 20 while controlling the components of the vehicle 20.

The functions of the vehicle 20 can be realized by execution of a vehicle program according to the present embodiment by a processor corresponding to the controller 26. That is, the functions of the vehicle 20 are realized by software. The vehicle program can cause a computer to function as the vehicle 20 by causing the computer to execute the operations of the vehicle 20. That is, the computer can function as the vehicle 20 by executing the operations of the vehicle 20 in accordance with the vehicle program.

Some or all of the functions of the vehicle 20 may be implemented by a dedicated circuit corresponding to the controller 26. That is, some or all of the functions of the vehicle 20 may be realized by hardware.

The controller 26 controls the positioner 22 to acquire positional information on the vehicle 20. The controller 26 controls the communication interface 21 to transmit the acquired positional information on the vehicle 20 to the information processing apparatus 10 via the network 2. The controller 26 may acquire, at established time intervals, the positional information on the vehicle 20 and transmit the acquired positional information on the vehicle 20 to the information processing apparatus 10. The time intervals may be set based on an average speed or the like of the vehicle 20.

<Configuration of Terminal Apparatus at Stop>

As illustrated in FIG. 2, the terminal apparatus 30 includes a communication interface 31, an output interface 32, a memory 33, and a controller 34.

The communication interface 31 is configured to include at least one communication module for connection to the network 2. The communication module is, for example, a communication module compliant with a mobile communication standard such as LTE, 4G, or 5G. However, the communication module is not limited to this. The communication module may be compliant with any communication standard.

The output interface 32 is capable of outputting data. The output interface 32 is configured to include at least one interface for output that is capable of outputting data. The interface for output is, for example, a display, a speaker, or the like. The display is, for example, an LCD, an organic EL display, or the like. However, the interface for output is not limited to this.

The memory 33 is configured to include at least one semiconductor memory, at least one magnetic memory, at least one optical memory, or a combination of at least two of these. The semiconductor memory is, for example, RAM, ROM, or the like. The RAM is, for example, SRAM, DRAM, or the like. The ROM is, for example, EEPROM or the like. The memory 33 may function as a main memory, an auxiliary memory, or a cache memory. The memory 33 stores data to be used for operations of the terminal apparatus 30 and data obtained by the operations of the terminal apparatus 30.

The controller 34 is configured to include at least one processor, at least one dedicated circuit, or a combination thereof. The processor is, for example, a general purpose processor such as a CPU or a GPU, or a dedicated processor that is dedicated to a specific process. The dedicated circuit is, for example, an FPGA, an ASIC, or the like. The controller 34 executes processes related to the operations of the terminal apparatus 30 while controlling the components of the terminal apparatus 30.

The functions of the terminal apparatus 30 are realized by execution of a first terminal program according to the present embodiment by a processor corresponding to the controller 34. That is, the functions of the terminal apparatus 30 are realized by software. The first terminal program causes a computer to execute the operations of the terminal apparatus 30, thereby causing the computer to function as the terminal apparatus 30. That is, the computer executes the operations of the terminal apparatus 30 in accordance with the first terminal program to thereby function as the terminal apparatus 30.

Some or all of the functions of the terminal apparatus 30 may be implemented by a dedicated circuit corresponding to the controller 34. That is, some or all of the functions of the terminal apparatus 30 may be realized by hardware.

<Configuration of Terminal Apparatus>

As illustrated in FIG. 2, each of the terminal apparatuses 40 includes a communication interface 41, a positioner 42, an input interface 43, an output interface 44, a memory 45, and a controller 46.

The communication interface 41 is configured to include at least one communication module for connection to the network 2. The communication module is, for example, a communication module compliant with a mobile communication standard such as LTE, 4G, or 5G. However, the communication module is not limited to this. The communication module may be compliant with any communication standard.

The communication interface 41 may be configured to further include a communication module compliant with contactless communication standards. The contactless communication standards include, for example, the NFC standards or the like.

The positioner 42 is capable of acquiring positional information on the terminal apparatus 40. The positioner 42 is configured to include at least one receiving module compliant with a satellite positioning system. The receiving module is, for example, a receiving module corresponding to the GPS. However, the receiving module is not limited to this. The receiving module may be a receiving module corresponding to any appropriate satellite positioning system.

The input interface 43 is capable of accepting an input from a user. The input interface 43 is configured to include at least one interface for input that is capable of accepting an input from a user. The interface for input is, for example, a physical key, a capacitive key, a pointing device, a touch screen integrally provided with a display, a microphone, or the like. However, the interface for input is not limited to this.

The output interface 44 is capable of outputting data. The output interface 44 is configured to include at least one interface for output that is capable of outputting data. The interface for output is, for example, a display, a speaker, or the like. The display is, for example, an LCD, an organic EL display, or the like. However, the interface for output is not limited to this.

The memory 45 is configured to include at least one semiconductor memory, at least one magnetic memory, at least one optical memory, or a combination of at least two of these. The semiconductor memory is, for example, RAM, ROM, or the like. The RAM is, for example, SRAM, DRAM, or the like. The ROM is, for example, EEPROM or the like. The memory 45 may function as a main memory, an auxiliary memory, or a cache memory. The memory 45 stores data to be used for operations of the terminal apparatus 40 and data obtained by the operations of the terminal apparatus 40.

The controller 46 is configured to include at least one processor, at least one dedicated circuit, or a combination thereof. The processor is, for example, a general purpose processor such as a CPU or a GPU, or a dedicated processor that is dedicated to a specific process. The dedicated circuit is, for example, an FPGA, an ASIC, or the like. The controller 46 executes processes related to the operations of the terminal apparatus 40 while controlling the components of the terminal apparatus 40.

The functions of the terminal apparatus 40 are realized by execution of a second terminal program according to the present embodiment by a processor corresponding to the controller 46. That is, the functions of the terminal apparatus 40 are realized by software. The second terminal program causes a computer to execute the operations of the terminal apparatus 40, thereby causing the computer to function as the terminal apparatus 40. That is, the computer executes the operations of the terminal apparatus 40 in accordance with the second terminal program to thereby function as the terminal apparatus 40.

Some or all of the functions of the terminal apparatus 40 may be implemented by a dedicated circuit corresponding to the controller 46. That is, some or all of the functions of the terminal apparatus 40 may be realized by hardware.

The controller 46 controls the positioner 42 to acquire positional information on the terminal apparatus 40. The controller 46 controls the communication interface 41 to transmit the acquired positional information on the terminal apparatus 40 to the information processing apparatus 10 via the network 2. The controller 46 may acquire, at established time intervals, the positional information on the terminal apparatus 40 and transmit the acquired positional information on the terminal apparatus 40 to the information processing apparatus 10. The time intervals may be set based on an average speed at which the user of the terminal apparatus 40 moves, or the like.

(Processing of Information Processing System)

<User Condition Acquisition Processing>

In the information processing apparatus 10, the controller 13 acquires a user condition, which is a condition for users to be targets to whom the object 3 is to be kept secret. In other words, the object 3 is kept secret from users who matches the user condition. The user condition may be set by setting users to be targets to whom the object 3 is to be kept secret. Alternatively, the user condition may be set by setting users who are permitted to see the object 3. In this case, the user condition is a condition for users other than the users who are permitted to see the object 3.

The user condition may be set according to a confidentiality level of the object 3. The confidentiality level may have any number of stages. As an example, the confidentiality level may have three stages: a highest level, a middle level, and a lowest level. For example, when the object 3 is an unpublished part, the confidentiality level of the object 3 is set to the highest level or the middle level. When the object 3 is a general purpose part, the confidentiality level of the object 3 is set to the lowest level.

When the confidentiality level of the object 3 is at the highest level, all users except specific employees of the facility are set in the user condition, as users to whom the object 3 is to be kept secret. Alternatively, in the user condition, the specific employees of the facility may be set as users who are permitted to see the object 3.

When the confidentiality level of the object 3 is at the middle level, the visitor 5 is set in the user condition, as a user to whom the object 3 is to be kept secret. Alternatively, in the user condition, employees of the facility may be set as users who are permitted to see the object 3.

When the confidentiality level of the object 3 is at the lowest level, no users are set in the user condition as users to whom the object 3 is to be kept secret. Alternatively, in the user condition, all users may be set as users who are permitted to see the object 3.

The user condition may be set by the manager 4. In this case, when loading the object 3 into the vehicle 20, the manager 4 inputs a user condition according to the confidentiality level of the object 3 from the input interface 43 of the terminal apparatus 40C. In the terminal apparatus 40C, the controller 46 controls the communication interface 41 to transmit the user condition accepted by the input interface 43 to the information processing apparatus 10 via the network 2. In the information processing apparatus 10, the controller 13 controls the communication interface 11 to receive the user condition from the terminal apparatus 40C via the network 2, to acquire the user condition. When loading the object 3 into the vehicle 20, the manager 4 may input information on a vehicle 20 into which the object 3 is to be loaded, that is, the target vehicle 20A, together with the user condition, from the input interface 43 of the terminal apparatus 40C. In the terminal apparatus 40C, the controller 46 may control the input interface 43 to accept the information on the target vehicle 20A together with the user condition. In the terminal apparatus 40C, the controller 46 may control the communication interface 41 to transmit the information on the target vehicle 20A, together with the user condition, to the information processing apparatus 10. In the information processing apparatus 10, the controller 13 may identify the target vehicle 20A by receiving, from the terminal apparatus 40C, the information on the target vehicle 20A, together with the user condition.

<First Determination Processing>

In the information processing apparatus 10, upon acquiring the user condition, the controller 13 determines whether a user matching the user condition is likely to take the target vehicle 20A. The processing of determining whether a user matching the user condition is likely to take the target vehicle 20A is also referred to as “first determination processing”.

As an example of the first determination processing, the controller 13 may determine whether a user matching the user condition is likely to take the target vehicle 20A, according to tour schedule information on the visitor 5. The tour schedule information includes, for example, information on spots at which the visitor 5 is scheduled to stop and correspondences between the spots and scheduled times of stopping the spots. For example, assuming that, in the user condition, the visitor 5 is set as a user to whom the object 3 is to be kept secret. In this case, the controller 13 analyzes the tour schedule information and the positional information on the target vehicle 20A, and determines whether the target vehicle 20A and the visitor 5 reach the same stop at the same time. When it is determined that the target vehicle 20A and the visitor 5 reach the same stop at the same time, the controller 13 determines that the visitor 5, as a user matching the user condition, is likely to take the target vehicle 20A.

As another example of the first determination processing, the controller 13 may determine whether a user matching the user condition is likely to take the target vehicle 20A, according to the positional information on the terminal apparatus 40A of the escort 6. Here, the positional information on the terminal apparatus 40A can coincide with the positional information on the escort 6 when the escort 6 is in possession of the terminal apparatus 40A. Since the escort 6 is leading the visitor 5, the positional information on the escort 6 can be regarded as the positional information on the visitor 5. In other words, the positional information on the terminal apparatus 40A can be regarded as the positional information on the visitor 5. For example, assuming that, in the user condition, the visitor 5 is set as a user to whom the object 3 is to be kept secret. In this case, the controller 13 analyzes the positional information on the terminal apparatus 40A and the positional information on the target vehicle 20A, and determines whether the target vehicle 20A and the visitor 5 reach the same stop at the same time. When it is determined that the target vehicle 20A and the visitor 5 reach the same stop at the same time, the controller 13 determines that the visitor 5, as a user matching the user condition, is likely to take the target vehicle 20A.

As yet another example of the first determination processing, the controller 13 may determine whether a user matching the user condition is likely to take the target vehicle 20A, according to identification information on a user who is about to get on the target vehicle 20A. The identification information on a user may be any information that uniquely identifies the user.

The identification information on a user may be data on a face image of the user who is about to get on the target vehicle 20A. In this case, in the target vehicle 20A, the controller 26 controls the imager 24 to generate data on a face image of a user who is about to get on the target vehicle 20A from the entrance/exit of the target vehicle 20A. The controller 26 controls the communication interface 21 to transmit the generated data on the face image of the user to the information processing apparatus 10 via the network 2. In the information processing apparatus 10, the controller 13 controls the communication interface 11 to receive the data on the face image of the user from the target vehicle 20A via the network 2. Here, the memory 12 may store in advance data on a face image of a user to be a target to whom the object 3 is to be kept secret. In this case, the controller 13 performs, for example, image recognition processing to determine whether the face image of the user received from the target vehicle 20A matches the face image of the user to be a target to whom the object 3 is to be kept secret. When it is determined that the face image of the user received from the target vehicle 20A matches the face image of the user to be a target to whom the object 3 is to be kept secret, the controller 13 determines that a user matching the user condition is likely to take the target vehicle 20A. The memory 12 may alternatively store in advance data on face images of users who are permitted to see the object 3. In this case, the controller 13 performs, for example, image recognition processing to determine whether the facial image of the user received from the target vehicle 20A matches the data on any of the face images of the users who are permitted to see the object 3. When it is determined that the face image of the user received from the target vehicle 20A does not match the data on any of the face images of the users who are permitted to see the object 3, the controller 13 determines that a user matching the user condition is likely to take the target vehicle 20A.

The identification information on a user may be acquired by the target vehicle 20A performing contactless communications. In this case, the identification information on a user may be acquired from a contactless integrated circuit (IC) card of the user or a contactless IC chip of a terminal apparatus, such as the terminal apparatus 40. The contactless IC card is, for example, an employee ID card, an electronic money card, a transportation card, or the like. For example, a user who is about to get on the target vehicle 20A holds the contactless IC card or the terminal apparatus over a predetermined point in the vicinity of the entrance/exit of the target vehicle 20A. In the target vehicle 20A, the controller 26 controls the communication interface 21 to perform contactless communication, to acquire the identification information on the user from the contactless IC card or terminal apparatus of the user. The controller 26 controls the communication interface 21 to transmit the acquired identification information on the user to the information processing apparatus 10 via the network 2. In the information processing apparatus 10, the controller 13 controls the communication interface 11 to receive the identification information on the user from the target vehicle 20A via the network 2. Here, the memory 12 may store in advance identification information on a user to be a target to whom the object 3 is to be kept secret. In this case, the controller 13 determines whether the identification information on the user received from the target vehicle 20A coincides with the identification information on the user to be a target to whom the object 3 is to be kept secret. When it is determined that the identification information on the user received from the target vehicle 20A coincides with the identification information on the user to be a target to whom the object 3 is to be kept secret, the controller 13 determines that a user matching the user condition is likely to take the target vehicle 20A. The memory 12 may alternatively store in advance identification information on users who are permitted to see the object 3. In this case, the controller 13 determines whether the identification information on the user received from the target vehicle 20A coincides with the identification information on any of the users who are permitted to see the object 3. When it is determined that the identification information on the user received from the target vehicle 20A does not coincide with the identification information on any of the users who are permitted to see the object 3, the controller 13 determines that a user matching the user condition is likely to take the target vehicle 20A.

<Notification Processing>

In the information processing apparatus 10, when it is determined that a user matching the user condition is likely to take the target vehicle 20A, the controller 13 may perform various types of processing to ensure the confidentiality of the object 3. For example, the controller 13 performs notification processing to ensure the confidentiality of the object 3. The notification processing may be processing to notify that a user matching the user condition should not take the target vehicle 20A, or processing to notify that a user matching the user condition is likely to take the target vehicle 20A.

As an example of the notification processing, the controller 13 may control the communication interface 11 to transmit, to the target vehicle 20A via the network 2, an output signal to cause output of a notification sound. In this case, in the target vehicle 20A, the controller 26 controls the communication interface 21 to receive the output signal from the information processing apparatus 10 via the network 2. When the output signal is received, the controller 26 controls the output interface 23 to output the notification sound, such as a buzzer, from a speaker. A user who is about to get on the target vehicle 20A can recognize that he/she should not take the target vehicle 20A by listening to the notification sound output by the target vehicle 20A. This notification processing may be performed when the first determination processing is performed using the identification information on a user. When the user holds a contactless IC card or the like over the predetermined point in the vicinity of the entrance/exit of the target vehicle 20A, as described above, the speaker of the output interface 23 that outputs the buzzer or another notification sound may be positioned near the predetermined point.

As another example of the notification processing, the controller 13 may identify stops at which the target vehicle 20A is scheduled to stop, by analyzing the positional information on the target vehicle 20A and/or operation schedule information on the target vehicle 20A. The controller 13 may identify only a stop at which the target vehicle 20A is scheduled to stop next, or all the stops at which the target vehicle 20A is scheduled to stop. The controller 13 may control the communication interface 11 to transmit the output signal via the network 2 to the terminal apparatus/apparatuses 30 of the identified stop/stops at which the target vehicle 20A is scheduled to stop. This output signal is a signal to cause the terminal apparatus/apparatuses 30 to output information indicating that a user should not take the target vehicle 20A. This notification processing may be performed when a user matching the user condition is likely to be waiting at the stop. In the terminal apparatus 30, the controller 34 controls the communication interface 31 to receive the output signal from the information processing apparatus 10 via the network 2. When the output signal is received, the controller 34 controls the output interface 32 to output the information indicating that the user should not take the target vehicle 20A. For example, the controller 34 controls the output interface 32 to display this information as an image on a display, or to output this information as a sound from a speaker. The output of such information from the output interface 32 allows the user waiting at the stop to recognize that he/she should not take the target vehicle 20A.

As yet another example of the notification processing, when a user matching the user condition is the visitor 5, the controller 13 may estimate a stop at which the visitor 5 is waiting. The controller 13 may estimate a stop at which the visitor 5 is waiting, by analyzing the positional information on the terminal apparatus 40A and/or the tour schedule information on the visitor 5. The controller 13 may control the communication interface 11 to transmit an output signal to the terminal apparatus 30 of the estimated stop. This output signal is a signal to cause the terminal apparatus 30 to output information indicating that the visitor 5 should not take the target vehicle 20A. In the terminal apparatus 30, the controller 34 controls the communication interface 31 to receive the output signal from the information processing apparatus 10 via the network 2. When the output signal is received, the controller 34 controls the output interface 32 to output information indicating that the visitor 5 should not take the target vehicle 20A. For example, the controller 34 controls the output interface 32 to display this information as an image on a display, or to output this information as a sound from a speaker. The output of such information from the output interface 32 allows the visitor 5 to recognize that he/she should not take the target vehicle 20A.

As yet another example of the notification processing, the controller 13 may control the communication interface 11 to transmit, to the terminal apparatus 40B of the driver of the target vehicle 20A via the network 2, a signal indicating that a user matching the user condition is likely to take the target vehicle 20A. In the terminal apparatus 40B, the controller 46 controls the communication interface 41 to receive this signal from the information processing apparatus 10 via the network 2. In the terminal apparatus 40B, when this signal is received, the controller 46 controls the output interface 44 to output information indicating that a user matching the user condition is likely to take the target vehicle 20A. For example, the controller 46 controls the output interface 44 to output this information as a sound from a speaker, or to display this information as an image on a display. This configuration allows the driver of the target vehicle 20A to know that a user matching the user condition is likely to take the target vehicle 20A. The driver of the target vehicle 20A can explain to the user not to take the target vehicle 20A or pass through a stop with a door of the target vehicle 20A closed so that the user does not get on.

As yet another example of the notification processing, the controller 13 may control the communication interface 11 to transmit, to the terminal apparatus 40C of the manager 4 via the network 2, a signal indicating that a user matching the user condition is likely to take the target vehicle 20A. In the terminal apparatus 40C, the controller 46 controls the communication interface 41 to receive this signal from the information processing apparatus 10 via the network 2. In the terminal apparatus 40C, when this signal is received, the controller 46 controls the output interface 44 to output information indicating that a user matching the user condition is likely to take the target vehicle 20A. For example, the controller 46 controls the output interface 44 to output this information as a sound from a speaker, or to display this information as an image on a display. This configuration allows the manager 4 to know that a user matching the user condition is likely to take the target vehicle 20A. For example, when the manager 4 is on board the target vehicle 20A, the manager 4 may explain to the user not to take the target vehicle 20A.

As yet another example of the notification processing, when a user matching the user condition is the visitor 5, the controller 13 may control the communication interface 11 to transmit, to the terminal apparatus 40A of the escort 6 via the network 2, a signal indicating that the visitor 5 should not take the target vehicle 20A. In the terminal apparatus 40A, the controller 46 controls the communication interface 41 to receive this signal from the information processing apparatus 10 via the network 2. In the terminal apparatus 40A, when this signal is received, the controller 46 controls the output interface 44 to output information indicating that the visitor 5 should not take the target vehicle 20A. For example, the controller 46 controls the output interface 44 to output this information as a sound from a speaker, or to display this information as an image on a display. With this configuration, the escort 6 can lead the visitor 5 so that the visitor 5 does not take the target vehicle 20A. For example, the escort 6 can take, with the visitor 5, the vehicle 20B that is different from the target vehicle 20A.

<Additional Processing>

In the information processing apparatus 10, the controller 13 may perform another type of processing different from the notification processing when it is determined that a user matching the user condition is likely to take the target vehicle 20A.

As an example, the controller 13 may control the communication interface 11 to transmit, to the target vehicle 20A via the network 2, a signal to cause a door of the target vehicle 20A to be kept closed. This processing may be performed when the driving of the target vehicle 20A is automated. In the target vehicle 20A, the controller 26 controls the communication interface 21 to receive the signal to cause the door of the target vehicle 20A to be kept closed, from the information processing apparatus 10 via the network 2. When this signal is received, the controller 26 controls the target vehicle 20A to pass through a stop with the door of the target vehicle 20A closed. This configuration reduces the possibility that a user matching the user condition takes the target vehicle 20A.

As another example, the controller 13 may control the communication interface 11 to transmit, to the target vehicle 20A, a command signal commanding the target vehicle 20A not to stop at a stop. This processing may be performed when the driving of the target vehicle 20A is automated. In the target vehicle 20A, the controller 26 controls the communication interface 21 to receive the command signal from the information processing apparatus 10 via the network 2. In the target vehicle 20A, when the command signal is received, the controller 26 controls the target vehicle 20A to pass without stopping at the stop. This configuration reduces the possibility that a user matching the user condition gets on the target vehicle 20A at the stop.

As yet another example, when a user matching the user condition is the visitor 5, the controller 13 may estimate a stop at which the visitor 5 is waiting. The controller 13 may estimate a stop at which the visitor 5 is waiting, by analyzing the positional information on the terminal apparatus 40A and/or the tour schedule information on the visitor 5. The controller 13 may control the communication interface 11 to transmit, to the target vehicle 20A via the network 2, a command signal commanding the target vehicle 20A not to stop at the estimated stop. This processing may be performed when the driving of the target vehicle 20A is automated. In the target vehicle 20A, the controller 26 controls the communication interface 21 to receive the command signal from the information processing apparatus 10 via the network 2. In the target vehicle 20A, the controller 26 controls the target vehicle 20A to pass without stopping at the stop. This configuration reduces the possibility that the visitor 5 gets on the target vehicle 20A at the stop.

<Second Determination Processing>

In the information processing apparatus 10, the controller 13 may determine whether a user matching the user condition is likely to be already in the target vehicle 20A. The processing of determining whether a user matching the user condition is likely to be already in the target vehicle 20A is also referred to as “second determination processing”. For example, the controller 13 may perform the second determination processing when it is determined that a user matching the user condition is likely to take the target vehicle 20A in the first determination processing.

As an example of the second determination processing, when a user matching the user condition is the visitor 5, the controller 13 may determine whether the target vehicle 20A is in motion. When the target vehicle 20A is in motion, the controller 13 may analyze the positional information on the terminal apparatus 40A and the positional information on the target vehicle 20A, to determine whether the position of the terminal apparatus 40A and the position of the target vehicle 20A coincide with each other. When it is determined that the position of the terminal apparatus 40A and the position of the target vehicle 20A coincide with each other, the controller 13 determines that the visitor 5, who is a user matching the user condition, is likely to be already in the target vehicle 20A.

When it is determined that a user matching the user condition is likely to be already in the target vehicle 20A, the controller 13 may control the communication interface 11 to transmit a warning signal to the terminal apparatus 40C of the manager 4 via the network 2. The warning signal is a signal to warn that a user matching the user condition is likely to be already in the target vehicle 20A. In the terminal apparatuses 40, the controller 46 controls the communication interface 41 to receive the warning signal from the information processing apparatus 10 via the network 2. In the terminal apparatus 40C, the controller 46 controls the output interface 44 to output information to warn that a user matching the user condition is likely to be already in the target vehicle 20A. For example, the controller 46 controls the output interface 44 to output this information as a sound from a speaker, or to display this information as an image on a display. With this configuration, the manager 4, who is in the target vehicle 20A, for example, can hide the object 3 from public view or request the user to get off the target vehicle 20A.

(Operations of Information Processing Apparatus)

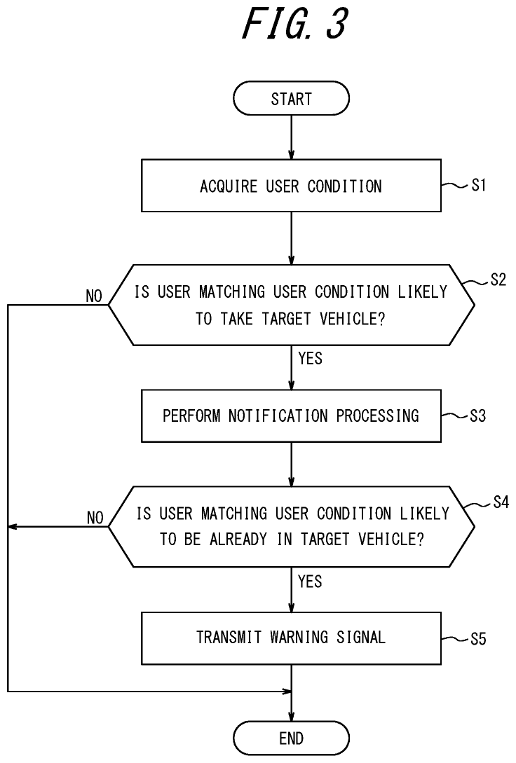

FIG. 3 is a flowchart illustrating the operations of the information processing apparatus 10 illustrated in FIG. 2. The operations correspond to an example of an information processing method according to the present embodiment. For example, when a user condition is transmitted from the terminal apparatus 40C of the manager 4 to the information processing apparatus 10, the controller 13 starts the processing of step S1.

The controller 13 acquires a user condition (step S1). The controller 13 determines whether a user matching the user condition is likely to take the target vehicle 20A (step S2). When the controller 13 has determined that a user matching the user condition is likely to take the target vehicle 20A (step S2: YES), the process proceeds to step S3. When the controller 13 has not determined that a user matching the user condition is likely to take the target vehicle 20A (step S2: NO), the process ends.

In the processing of step S3, the controller 13 performs the notification processing. In the processing of step S4, the controller 13 determines whether a user matching the user condition is already in the target vehicle 20A. When the controller 13 has determined that a user matching the user condition is in the target vehicle 20A (step S4: YES), the process proceeds to step S5. When the controller 13 has determined that a user matching the user condition is not in the target vehicle 20A (step S4: NO), the process ends.

In the processing of step S5, the controller 13 controls the communication interface 11 to transmit a warning signal to the terminal apparatus 40C of the manager 4 via the network 2.

After completion of the process illustrated in FIG. 3, the controller 13 may perform the processing of step S1 again upon acquiring a new user condition.

Thus, in the information processing apparatus 10, the controller 13 acquires a user condition and determines whether a user matching the user condition is likely to take the target vehicle 20A. This configuration allows the controller 13 to perform various types of processing to ensure the confidentiality of the object 3 when it is determined that a user matching the user condition is likely to take the target vehicle 20A. Therefore, according to the present embodiment, the confidentiality of the object 3 to be transported can be ensured.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, in the embodiment described above, the vehicles 20 are described as circulating the facility. However, the vehicles 20 may travel to any location other than the facility.

For example, an embodiment in which a general purpose computer functions as the information processing apparatus 10 according to the above embodiment can also be implemented. Specifically, a program in which processes for realizing the functions of the information processing apparatus 10 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. An information processing apparatus comprising a controller configured to:
acquire a user condition being a condition for a user to be a target to whom an object is to be kept secret; and
determine whether a user matching the user condition is likely to take a target vehicle transporting the object.

2. The information processing apparatus according to claim 1, further comprising a communication interface,
wherein when it is determined that a user matching the user condition is likely to take the target vehicle, the controller controls the communication interface to transmit, to the target vehicle, an output signal to cause output of a notification sound.

3. The information processing apparatus according to claim 1, further comprising a communication interface,
wherein when it is determined that a user matching the user condition is likely to take the target vehicle, the controller controls the communication interface to transmit, to a terminal apparatus of a stop at which the target vehicle is scheduled to stop, an output signal to cause the terminal apparatus to output information indicating that the user should not take the target vehicle.

4. The information processing apparatus according to claim 1, further comprising a communication interface,
wherein when it is determined that a user matching the user condition is likely to take the target vehicle, the controller controls the communication interface to transmit, to a terminal apparatus of a driver of the target vehicle, a signal indicating that a user matching the user condition is likely to take the target vehicle.

5. The information processing apparatus according to claim 1, further comprising a communication interface,
wherein when it is determined that a user matching the user condition is likely to ride on the target vehicle, the controller controls the communication interface to transmit, to a terminal apparatus of a manager managing the object, a signal indicating that a user matching the user condition is likely to take the target vehicle.

6. The information processing apparatus according to claim 1, further comprising a communication interface,
wherein when it is determined that a user matching the user condition is likely to take the target vehicle, the controller controls the communication interface to transmit, to the target vehicle, a signal to keep a door of the target vehicle closed.

7. The information processing apparatus according to claim 1, further comprising a communication interface,
wherein when it is determined that a user matching the user condition is likely to take the target vehicle, the controller controls the communication interface to transmit, to the target vehicle, a command signal commanding the target vehicle not to stop at a stop.

8. The information processing apparatus according to claim 1, further comprising a communication interface,
wherein
the target vehicle is configured to circulate within a predetermined facility, and
when a user matching the user condition is a visitor to the facility, the controller controls the communication interface to transmit, to a terminal apparatus of an escort leading the visitor, a signal indicating that the visitor should not take the target vehicle.

9. The information processing apparatus according to claim 1, further comprising a communication interface,
wherein
the target vehicle is configured to circulate within a predetermined facility, and
when a user matching the user condition is a visitor to the facility, the controller estimates a stop at which the visitor is waiting, and controls the communication interface to transmit, to the target vehicle, a command signal commanding the target vehicle not to stop at the stop.

10. The information processing apparatus according to claim 1, further comprising a communication interface,
wherein
the target vehicle is configured to circulate within a predetermined facility, and
when a user matching the user condition is a visitor to the facility, the controller estimates a stop at which the visitor is waiting, and controls the communication interface to transmit, to a terminal apparatus of the stop, an output signal to cause the terminal apparatus to output information indicating that the visitor should not take the target vehicle.

11. The information processing apparatus according to claim 8, wherein the controller is configured to determine whether a user matching the user condition is likely to take the target vehicle, according to tour schedule information on the visitor.

12. The information processing apparatus according to claim 8, wherein the controller is configured to determine whether a user matching the user condition is likely to take the target vehicle, according to positional information on a terminal apparatus of an escort leading the visitor.

13. The information processing apparatus according to claim 8, wherein a visitor is set to the user condition, as a user to be a target to whom the object is to be kept secret.

14. The information processing apparatus according to claim 2, wherein when it is determined that a user matching the user condition is likely to be already in the target vehicle, the controller controls the communication interface to transmit, to a terminal apparatus of a manager managing the object, a warning signal warning that a user matching the user condition is likely to be already in the target vehicle.

15. The information processing apparatus according to claim 1, wherein the controller is configured to determine whether a user matching the user condition is likely to take the target vehicle, according to identification information on a user who is about to get on the target vehicle.

16. The information processing apparatus according to claim 15, wherein the identification information on the user is data on a face image of the user who is about to get on the target vehicle.

17. The information processing apparatus according to claim 15, wherein the identification information on the user is acquired by the target vehicle performing contactless communication.

18. An information processing system comprising:
the information processing apparatus according to claim 1; and
at least one vehicle including the target vehicle.

19. An information processing method comprising:
acquiring a user condition being a condition for a user to be a target to whom an object is to be kept secret; and
determining whether a user matching the user condition is likely to take a target vehicle transporting the object.

20. The information processing method according to claim 19, further comprising transmitting, to the target vehicle, an output signal to cause output of a notification sound when it is determined that a user matching the user condition is likely to take the target vehicle.
